(19) United States
(12) Patent Application Publication
(10) Pub. No.: US 2016/0032577 A1
(43) Pub. Date: Feb. 4, 2016

(54) FILL VALVE REGULATOR AND ASSEMBLY

(71) Applicant: LAVELLE INDUSTRIES, INC., Burlington, WI (US)

(72) Inventor: Kevin J. Guthrie, Wind Lake, WI (US)

(21) Appl. No.: 14/810,756

(22) Filed: Jul. 28, 2015

Related U.S. Application Data
(60) Provisional application No. 62/030,127, filed on Jul. 29, 2014.

(51) Int. Cl. E03D 11/13; F16K 1/34

(52) U.S. Cl. CPC E03D 11/13; F16K 1/34

(57) ABSTRACT

A fill valve regulator and assembly for flush systems used in gravity flush toilets allows water to flow into a fill valve at a uniform rate regardless of supply pressure variations. The regulator has an inlet riser which comprises an open bore defined by a riser wall. A guide body is situated within the open bore, the guide body comprising a lower portion having an opening and a shut off seal. A plunger slides within the guide body and a spring that is operable to bias the plunger away from the shut off seal creates an open continuum from the opening in the lower portion through the plunger, the guide body and the inlet riser, the spring being compressible if the spring bias is overcome by a force on the plunger such that the lower portion of the plunger is operable to seal against the shut off seal.

This application claims the benefit of U.S. Provisional Application No. 62/030,127, filed Jul. 29, 2014.

### FIELD OF THE INVENTION

The present invention relates generally to plumbing fixtures and to the component parts that are used in them. More particularly, it relates to a fill valve regulator and assembly for flush systems used in gravity flush toilets. It also relates to such a fill valve regulator and assembly that allows water to flow into a fill valve at a uniform rate regardless of supply pressure variations. That is, the regulator of the present invention changes static water pressure which reduces stress on mechanical parts used within the fill valve assembly, particularly those made of plastic and rubber. It is to be understood that the present invention is not a flow control regulator which only changes dynamic pressure while water is flowing.

### BACKGROUND OF THE INVENTION

Conventional toilets typically employ a number of essential components. First, a porcelain water tank is mounted immediately above a porcelain bowl from which a quantity of water is rapidly drained in order to flush waste from the bowl into the sewer system. One very common design uses a flapper valve made of an elastomeric material that covers the drain outlet of the tank. When the flush handle on the outside of the tank is manually depressed the flapper valve is lifted via a chain or other connecting means and the head of water in the tank drains through flush valve and the drain outlet, the outlet being normally covered by the flapper valve. The flapper valve is typically designed with an inverted air chamber so that it initially floats as it is lifted away from the drain outlet in the bottom of the tank. This allows sufficient flushing water to flow into the bowl even if the user immediately releases the flush handle. When the water level in the tank drops, the tank is automatically refilled through a fill valve connected to a high pressure water supply line.

The typical fill valve for the tank comprises a ballcock or pilot fill valve mounted in the tank on top of a riser which extends through an opening in the bottom of the tank and is connected to a pressurized water line in the house. When the tank drains, a float connected to the ballcock or pilot fill valve descends. This activates the ballcock or pilot fill valve and it begins to refill the tank with water at a rate much slower than the rate at which water flows through the drain outlet. When the tank is nearly empty, the flapper valve closes. The tank continues to refill as the float connected to the ballcock or pilot fill valve rises. At the same time water from the ballcock or pilot fill valve enters an overflow tube and refills the bowl to the normal standing water level to provide a trap seal. Once the float reaches a predetermined height indicating that the tank is full, the ballcock or pilot fill valve completely turns off.

The foregoing general conventional arrangement is still widely used today. In the experience of this inventor, however, there is a need to provide a water inflow regulator such that water can be fed into the fill valve at a substantially consistent flow rate regardless of variations in the supply line water pressure.

### SUMMARY OF THE INVENTION

In accordance with the foregoing, a fill valve regulator and assembly has been devised by this inventor. In the assembly, a water inlet riser tube is provided, which tube has a base that is secured within the bottom of the water tank. The tube has an inlet that is designed to receive water flowing into the tank. The tube allows water to flow upwardly toward a point above the bottom of the water tank. It is within the bottom portion of the inlet riser tube that the fill valve regulator of the present in invention is disposed.

In operation, water first flows up through the riser tube inlet and then around a shut off seal, plunger and spring assembly, which is the essence of the fill valve regulator. More specifically, water flows around the shut off seal and through a bore that is defined within the plunger. By design, the lower area of the plunger is one-quarter that of the upper area of the plunger. In this way, the pressure contained within the pressure vessel is converted into a downward force due to the difference in areas of the plunger. However, a spring is disposed about the plunger, the spring being “captured” within a compression chamber that is defined by a lower face of the plunger, an upper face of a guide body, an outer face of the plunger and an inner face of the inlet riser tube. The spring within the regulator has a preload force built into it which allows the plunger to shuttle or be in equilibrium (balanced) while the main valve is opened. When the main valve is closed, the upper plunger area overcomes the lower area and the spring, forcing the plunger downwardly to close the fill valve regulator.

Significantly, the spring can be changed to accommodate the “window” of pressure that is needed to properly operate the fill valve. The amount of pressure can be measured in pounds per square inch or, more accurately, pound-force per square inch (“psi”), which is a unit of pressure or of stress based on avoirdupois units. In short, it is the pressure resulting from a force of one pound-force applied to an area of one square inch. Further, such pressure can also be measured in pounds per square inch gage (psig), indicating that the pressure is relative to atmospheric pressure. In the fill valve regulator of the present invention, the inlet pressure could be 150 psig. and the spring can be set to meter water at 50 psig dynamic and the static shut-off will be between 65 and 75 psig (the delay being due to the time it takes the plunger to close). It is to be understood that there is are two sides to the static water pressure that is present in a system that uses the fill valve regulator of the present invention. This will be presented and considered in more detail later in the detailed description.

Lastly, the compression chamber in the fill valve regulator of the present invention includes a bleed hole to allow the spring and plunger to move freely within the chamber. The bleed hole is disposed below the water line of the toilet tank and is open to that tank. If the seal within the regulator were to fail, the water would simply flow into the tank and down an overflow tube disposed within the tank, which tube is typically part of the flush valve assembly.

The foregoing and other features of the fill valve regulator and assembly of the present invention will be apparent from the following detailed description when read in conjunction with the accompanying drawings.

### BRIEF DESCRIPTION OF THE DRAWINGS

FIG. 1 is a side elevational view of a fill valve within which the fill valve regulator and assembly of the present invention is used.

FIG. 1A is a cross sectioned view of the fill valve and assembly shown in FIG. 1.

FIG. 2 is an enlarged side elevational and the cross sectioned view of the regulator that is used in the fill valve shown in FIG. 1.

### DETAILED DESCRIPTION

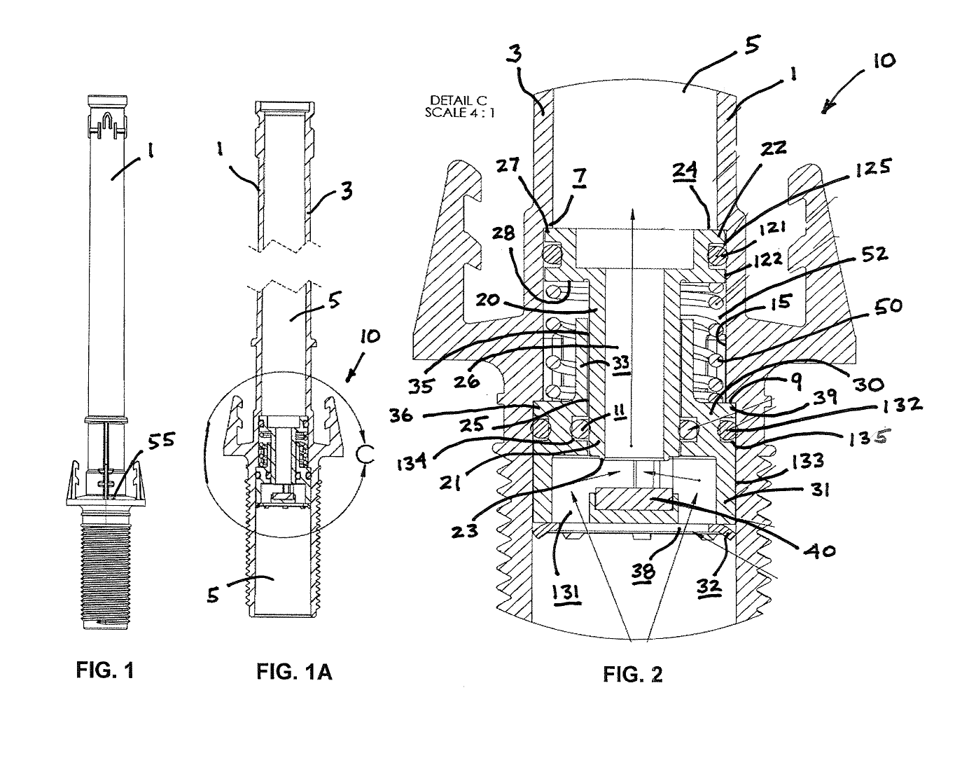

Referring now to the drawings in detail, wherein like-numbered elements refer to like elements throughout, FIG. 1 illustrates a tubular inlet riser 1 of the type that would be mounted within a toilet tank (not shown). It is to be understood that a main control valve assembly (also not shown) would typically be mounted on the upper end of the inlet riser 1. The inlet riser 1 comprises a riser bore 5 defined by a riser wall 3. See FIG. 1A.

Referring to both FIGS. 1A and 2, they illustrate a regulator and assembly that is constructed in accordance with a preferred embodiment of the invention, the regulator and assembly being designated generally by the numeral 10. Moving downwardly from the top of the inlet riser 1 along riser wall 3 is a first circumferential ledge 7 and a second circumferential ledge 9.

The fill valve regulator and assembly 10 of the present invention generally comprise the following components: a plunger 20, a guide body 30, a shut off seal 40 and a spring 50. The plunger 20 comprises a lower plunger portion 21 and an upper plunger portion 22. The lower plunger portion 21 comprises a bottom shut-off portion 23 and the upper plunger portion 22 comprises a top surface 24. A plunger bore 26 extends through the plunger 20, which bore 26 provides a water flow continuum through the inlet riser 1. Although a cylindrical bore 26 is preferred, such is not a limitation of the present invention. The top surface 24 of the plunger 20 comprises a circumferential shoulder 27 which, when in contact with the first circumferential ledge 7 of the inlet riser bore 5, prevents the plunger 20 from moving upwardly. The lower plunger portion 21 comprises an outer cylindrical surface 25 having an outer diameter. The upper plunger portion 22 likewise comprises an outer cylindrical surface 122 in which is formed a circumferential groove 125 for receiving an O-ring 121.

The guide body 30 is likewise disposed within the inlet riser bore 5, just below the plunger 20 although not completely. That is, the guide body 30 comprises a lower portion 31 and an upper portion 33, the upper portion 33 having a bore 35 through which the outer cylindrical surface 25 of the plunger 20 is vertically movable. Although the outer diameter of the plunger surface 25 is slightly less than the inner diameter of the bore 35 of the guide body 30, water is prevented from flowing between those two components by means of an O-ring 11 that is disposed within a circumferential groove 134 that is defined within the surface of the bore 35 of the guide body 30, the O-ring 11 impinging on the outer plunger surface 25.

The guide body 30 further has a medial portion 36 that comprises a circumferential shoulder 39 which, when in contact with the second circumferential ledge 9 of the riser bore 5, prevents the guide body 30 from moving upwardly. Further, a retainer 32 is provided to prevent the guide body 30 from moving downwardly. In effect, the guide body 30 is stationary within the assembly 10 whereas the plunger 20 is vertically movable within the assembly and within a portion of the guide body 30. The retainer 32 comprises the shut-off seal 40 and at least one aperture 38 to allow a water flow continuum through the retainer 32, around the shut-off seal 40, through the plunger bore 26 and through the inlet riser bore 5. The lower portion 31 of the guide body comprises an opening 131 which allows this flow, the opening 131 being substantially greater in diameter than that of the lower plunger portion 21. An O-ring 132 is also disposed within an aperture 135 that is defined within the outer surfaces 133 of the lower portion 31 of the guide body 30. It is also to be noted that the outer diameter of the upper portion 33 of the guide body 30 is less than that of the outer diameter of the lower portion 31.

Lastly, a spring 50 is disposed within a compression chamber 52 that is formed by a bottom face 28 of the upper portion 22 of the plunger 20, the inner face 15 of the inlet riser bore 5, and the upper portion 33 of the guide body 30. The compression chamber 52 in the fill valve regulator 10 of the present invention includes a bleed hole 55 to allow the spring 50 and the plunger 20 to move freely within the chamber 52. See FIG. 1. The bleed hole 55 is disposed below the water line of the toilet tank and is open to that tank. If the O-rings 11, 121, 132 within the regulator 10 were to fail, the water would simply flow into the tank and down an overflow tube disposed within the tank, which tube is typically part of the flush valve assembly.

In operation, water first flows up through the riser tube inlet bore 5 and then around the shut off seal 40 and through the plunger 20. By design, the lower area of the plunger 20 is one-quarter that of the upper area of the plunger 20. In this way, the pressure contained within the pressure inlet riser bore 5 is converted into a downward force due to the difference in areas of the plunger 20. However, the spring 50 has a preload force built into it which allows the plunger 20 to shuttle or be in equilibrium (balanced) while the main valve (not shown) is opened. When the main valve is closed, the upper plunger area overcomes the lower area and the spring 50, forcing the plunger 20 downwardly to close the fill valve regulator 10.

As mentioned at the outset, the spring 50 can be changed to accommodate the “window” of pressure that is needed to properly operate the fill valve. In the fill valve regulator 10 of the present invention, the inlet pressure could be 150 psig. and the spring 50 can be set to meter water at 50 psig dynamic and the static shut-off will be between 65 and 75 psig (the delay being due to the time it takes the plunger 20 to close).

As stated at the outset, the fill valve regulator 10 and assembly in accordance with the present invention allows water to flow into a fill valve at a uniform rate regardless of supply pressure variation. The regulator 10 changes the static pressure which reduces stress on the mechanical parts such as those made of plastic and rubber. This is not a flow control regulator which only changes dynamic pressure while water is flowing.

For example, in the fill valve regulator of the present invention, it was also noted at the outset that the inlet pressure could be 150 psig. and the spring can be set to meter water at 50 psig dynamic and the static shut-off will be between 65 and 75 psig (the delay being due to the time it takes the plunger to close). It is to be understood that there is are two sides to the static water pressure that is present in a system that uses the fill valve regulator of the present invention. That is, the is a Side A and a Side B to the static water pressure. Side A is the pressure of the incoming water up to bottom shut-off portion 23 of the lower plunger portion 21 and the shut off seal 40 (150 psig). Side B would be the water between the bottom shut-off portion 23 of the lower plunger portion 21 and the shut off seal 40 up to the main valve (65-75 psig).

What is claimed is:

1. A fill valve regulator comprising:
an inlet riser comprising an open bore defined by a riser wall;
a guide body situated within the open bore of the inlet riser and fixed to the riser wall, the guide body comprising a lower portion having an opening and a shut off seal;
a plunger comprising a lower plunger portion, an upper plunger portion and an open bore, the plunger being slidingly situated within the guide body; and
a spring operable to bias the plunger away from the shut off seal such that an open continuum exists from the opening in the lower portion through the plunger, the guide body and the inlet riser, the spring being compressible if the spring bias is overcome by a force on the plunger such that the lower portion of the plunger is operable to seal against the shut off seal.

2. The fill valve regulator of claim 1 wherein the guide body further comprises a shoulder and the riser wall of the inlet riser further comprises a first perimeter ledge to prevent upward movement of the guide body relative to the inlet riser

3. The fill valve regulator of claim 1 wherein the guide body further comprises a lower portion comprising a retainer operable to prevent the guide body from moving downwardly relative to the inlet riser.

4. The fill valve regulator of claim 1 wherein the bore of the upper plunger portion is larger than the bore of the lower plunger portion.

5. The fill valve regulator of claim 1 wherein the area of the bore of the upper plunger portion is approximately four times as large as the area of the bore of the lower plunger portion.

6. A toilet tank fill valve regulator assembly for use within a toilet tank, the assembly comprising:
an inlet riser, the inlet riser being disposed within the toilet tank and comprising an open bore defined by a riser wall;
a guide body situated within the open bore of the inlet riser and fixed to the riser wall, the guide body comprising a lower portion comprising a retainer having an opening and a shut off seal;
a plunger comprising a lower plunger portion, an upper plunger portion and an open bore, the plunger being slidingly situated within the guide body; and
a spring operable to bias the plunger away from the shut off seal such that a continuum exists from the opening in the retainer through the plunger, the guide body and the inlet riser when the spring biases the plunger away from the shut off seal, the spring being further operable to compress so as to permit the lower plunger portion to seal against the shut off seal thereby closing the continuum between the guide body and the plunger.

7. The toilet tank fill valve regulator assembly of claim 6 wherein the guide body further comprises a shoulder and the riser wall of the inlet riser further comprises a first perimeter ledge to prevent upward movement of the guide body relative to the inlet riser

8. The toilet tank fill valve regulator assembly of claim 6 wherein the guide body further comprises a lower portion comprising a retainer operable to prevent the guide body from moving downwardly relative to the inlet riser.

9. The toilet tank fill valve regulator assembly of claim 6 wherein the bore of the upper plunger portion is larger than the bore of the lower plunger portion.

10. The toilet tank fill valve regulator assembly of claim 6 wherein the area of the bore of the upper plunger portion is approximately four times as large as the area of the bore of the lower plunger portion.

11. The toilet tank fill valve regulator assembly of claim 6 wherein the lower portion of the plunger is operable to seal against the shut off seal if the spring bias is overcome by a force on the plunger.
